(19) United States
(12) Patent Application Publication
(10) Pub. No.: US 2002/0127455 A1
(43) Pub. Date: Sep. 12, 2002

(54) Ceria-based solid oxide fuel cells

(75) Inventors: Ai Quoc Pham, San Jose, CA (US); Robert S. Glass, Livermore, CA (US)

Correspondence Address: Alan H. Thompson, Deputy Lab Counsel for Intellectual Property Law, Lawrence Livermore National Laboratory, P.O. Box 808, L-703, Livermore, CA, 94551, US

(73) Assignee: The Regents of the University of California

(21) Appl. No.: 10/025,399

(22) Filed: Dec. 17, 2001

Related U.S. Application Data
(60) Provisional application No. 60/274,200, filed on Mar. 8, 2001.

(51) Int. Cl. H01M 8/10; H01M 4/86; H01M 4/88

(52) U.S. Cl. 429/33; 429/40; 502/101

(57) ABSTRACT

High-performance intermediate temperature solid oxide fuel cells (SOFCs). The SOFCs are ceria-based structures that can achieve a power output of 300 mW/cm² at an operating temperature below 600° C. By way of example, the fuel cell as an anode made of NiO/doped-ceria, a thin film of doped-ceria and/or doped zirconia electrolyte is deposited on the anode, and a cathode of cobalt iron based material, such as (La, Sr)(Co, Fe)O₃ or cobalt, ion, magnesium based material, is deposited on top of the electrolyte, and can operate at a temperature of 550° C. The various layers may be deposited by colloidal spray deposition or aerosol spray casting.

### RELATED APPLICATION

The present invention relates to and claims priority under 35 USC 120 to Provisional Application No. 60/274200 filed Mar. 8, 2001, entitled “Ceria-Based Solid Oxide Fuel Cells”.

The United States Government has rights in this invention pursuant to Contract No. W-7405-ENG-48 between the United States Department of Energy and the University of California for the operation of Lawrence Livermore National Laboratory.

### BACKGROUND OF THE INVENTION

This invention relates to solid oxide fuel cells (SOFCs), particularly high performance intermediate temperature SOFCs, and more particularly to ceria-based SOFCs with doped-ceria in the anode, and a thin film of doped-ceria as the electrolyte and a cathode composed of cobalt iron based materials, with at least the doped ceria being deposited by colloidal spray deposition.

SOFCs have attracted much interest because of their high efficiency and low emissions characteristics. However, despite several successful demonstrations by Siemens Westinghouse, the world leader in tubular SOFC technology, SOFCs are still not close to commercialization. This is because of the high cost and of the high complexity of the fuel cell systems.

Since hydrogen, which is the preferred for most fuel cells, is not available directly, fuel cells must use hydrocarbon fuels (fossil fuels). Because of their low reactivity, hydrocarbon fuels must be reformed to generate a more reactive mixture of hydrogen and carbon monoxide before entering the fuel cell anode. The reforming stage adds more complexity to the fuel system, representing about one third of the total cost while also causing a loss in overall system efficiency. Indeed, the typical reforming approach is the steam reforming which is an endothermic process and which requires a large excess of steam in order to prevent carbon deposition problems. Up to 20% of the energy content of the fuel can be consumed during the reforming stage.

If hydrocarbon fuels, especially natural gas, could be used directly in the fuel cells, the fuel cell system would be much simpler and the cost would be significantly lower. Such a possibility is theoretically possible for SOFCs because their high operating temperatures enhance the oxidation kinetics. However, too high a temperature results in carbon deposition and performance degradation while too low a temperature does not yield an acceptable power output. The Westinghouse SOFC for instance, must be operated at 1000° C. in order to yield a peak power density in the order of 300 mW/cm². Recently, some planar SOFCs have shown very high performance at reduced temperature. For instance, Honeywell has demonstrated a power density of 650 mW/cm² at 800° C. However, a much lower operating temperature is required in order to consider direct use of natural gas without having carbon can be considered negligible for temperatures below 500° C. For such a low temperature, current SOFCs do not have adequate power output.

The development of fuel cell operating at intermediate temperatures (400-700° C.) would have also additional benefits such as: use of low cost metal interconnect, more options for sealing, less thermal stress, faster start-up, less insulation, etc.

The present invention provides a fuel cell structure that can achieve the power output of the above-referenced Siemens Westinghouse fuel cell (300 mW/cm²) at much lower operating temperature (below 600° C.). An embodiment of a fuel cell of this invention includes an anode of Ni/doped-ceria, a thin film of doped-ceria and/or doped zirconia electrolyte, and a cathode of cobalt iron based oxides being deposited by colloidal spray deposition, described and claimed ion U.S. Application Ser. No. 09/293,446 filed Apr. 16, 1999 entitled “Colloidal Spray Method for Low Cost Thin Coating Deposition”, and assigned to the same assignee.

### SUMMARY OF THE INVENTION

It is an object of the present invention to provide an intermediate temperature solid oxide fuel cell.

A further object of the invention is to provide a high performance intermediate temperature ceria-based solid oxide fuel cell.

A further object of the invention is to provide a fuel cell operating at intermediate temperatures capable of producing a power density of at least 300 mW/cm² at operating temperatures below 600° C.

Another object of the invention is to provide a ceria-based solid oxide fuel cell, utilizing doped-ceria in the anode and intermediate the electrolyte and the cathode.

Another object of the invention is to provide a ceria-based solid oxide fuel cell wherein components thereof are formed by colloidal spray deposition.

Another object of the invention is to provide a ceria-based solid oxide fuel cells capable of producing at an operating temperature of 550° C. a power density of 400 mW/cm² for hydrogen fuel and 320 mW/cm² for methane fuel.

Other objects and advantages of the present invention will become apparent from the following description and accompanying drawings. Basically, the invention involved a ceria-based solid oxide fuel cell (SOFC), wherein at least the ceria is deposited by colloidal spray deposition, whereby high power densities can be obtained at intermediate temperatures (400-700° C.). The SOFC of this invention which operates at intermediate temperatures has additional benefits, such as use of low cost metal interconnect, more options for sealing, less thermal stress, faster startup, and less insulation. The SOFC of this invention can achieve the power output of the above referenced Siemens Westinghouse cell of 300 mW/cm² at lower operating temperature (below 600° C.).

The SOFCs of this invention can utilize hydrogen and methane fuels at 550° C., with a peak power for hydrogen fuel of 400 mW/cm² and for methane fuel of 320 mW/cm².

### BRIEF DESCRIPTION OF THE DRAWINGS

The accompanying drawings, which incorporated into and form a part of the disclosure, illustrate an embodiment of the invention and, together with the description, serve to explain the principles of the invention.

FIG. 1 is a cross-section of an embodiment of an intermediate temperature solid oxide fuel cell made in accordance with the present invention.

FIG. 2 graphically illustrate voltage/current density plot of the SOFC of the present invention for hydrogen and methane fuels at 550° C.

FIG. 3 graphically illustrates power density plots at 550° C. for the hydrogen and methane fuels.

FIG. 4 graphically illustrates power density plots at 600° C. for the hydrogen and methane fuels.

### DETAILED DESCRIPTION OF THE INVENTION

The invention is directed to ceria-based solid oxide fuel cells operating at intermediate temperatures (400-700° C.). The fuel cells of the present invention have the following advantages:

1. The low operating temperature enables direct use of methane without pre-reforming and without risk of carbon deposition, which in turn has the advantages of: a) significant simplification of the fuel cell system, b) reduction of fuel cell system cost by about 30%, and c) higher thermodynamic efficiency.

2. Other hydrocarbons can be considered as fuels with much more simplicity, especially methanol, propane, butane, although the direct use may result in some carbon deposition because these gases are less stable than methane, the low temperature will reduce the need for large excess of steam.

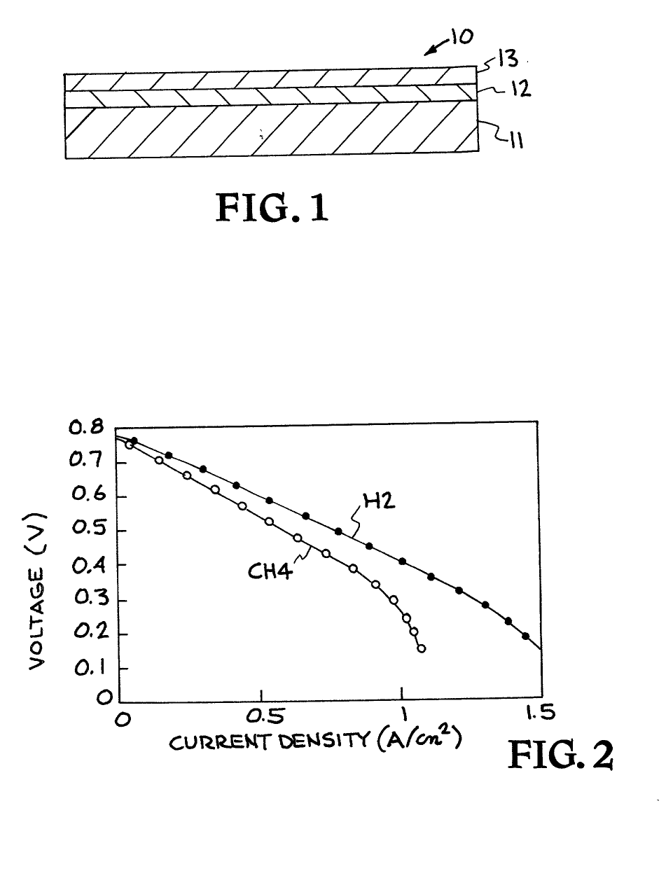

The fuel cell of this invention is illustrated in FIG. 1, wherein the basic structure of the cell, indicated generally at 10, comprises a thick anode 11, a thin film electrolyte 12, and a cathode 13. In one embodiment of the fuel cell the anode 11 is made of NiO/doped-ceria. Typical doping elements include samarium oxide and gadolinium oxide, but may additionally include oxides of all lanthanide elements and yttria. Preferred elements are samarium and gadolinium. The doping can also be done using two or more elements of the lanthanides. A pore former such as starch or carbon is used to create pores in the structure. A thin film of doped ceria and/or doped zirconia electrolyte 12 is deposited on to the anode 11 using colloidal spray deposition (CSD) or aerosol spray casting (ASC). The cathode 13 of cobalt iron based material, such as (La, Sr)(CoFe)O₃, is deposited on the electrolyte layer 12 using the CSD technique. Also, (La,Ca) (Co, Fe, Mn) O₃ may be deposited.

By way of example the NiO/doped-ceria anode may have a thickness of 200 to 1000 μm, a doped-ceria electrolyte layer thickness of 2 to 40 μm. At least the doped-ceria is deposited by the CSD technique. The electrolyte layer may be of either doped-ceria or doped-zirconia, with the dopant for the zirconia being yttria or scandia, for example; or the electrolyte may be composed of layers of doped-ceria and doped-zirconia, or the doped-ceria and doped-zirconia may be deposited as a mixture by the CSD technique. Also, to prevent reaction between the zirconia electrolyte and the cobalt iron based electrode, a thin layer of doped-ceria is deposited therebetween.

As pointed out above, at least the doped-ceria is deposited by the colloidal spray deposition (CSD) technique of above-referenced application Ser. No. 09/293,446. The following sets forth a brief description of the CSD technique and apparatus for carrying out the technique.

A colloidal sol is delivered via a pumping apparatus, such as an ultrasonic nozzle, that sprays a mist of fine droplets onto a substrate that has been heated to a desired temperature by a heater which may or may not contact the substrate. The particles of the colloidal sol are dispersed onto the substrate as a mist of droplets of the mixture, with the droplet usually being of maximum cross-section dimension of less than 100 microns, and preferably from about 1 to about 50 microns. While carious spraying apparatus may be used, ultrasonic spraying is a preferred mode.

The CDS method involves hearing the substrate close to or above the coiling point of the solvent. Upon impact of the droplets on the heated substrate, the solvent evaporates leaving the powder in the form of a compact layer of the particles, i.e., a green film. The essentially instantaneous removal of the solvent by heating allows a continuous deposition of the coating. Following the coating step, the substrate and the coating can be co-sintered at high temperature to form a fully dense, sintered coating.

A substrate comprising any material may be coated by the method, including for instance, glasses, metals, ceramics, and the like. However, the best results are usually obtained with substrates having at least some porosity. The substrate surface can have any shape, including planar or non-planar surfaces. The substrate can have a low surface area to be coated or the method of the invention can be scaled up to coat objects of very large surface areas.

The solvent employed to suspend the particles can be an organic liquid, aqueous liquid or a mixture of both. The selection of the solvent is determined by the material(s) to be coated as well as the substrates. The solvent must be compatible with the powder (i.e., particles) of the coating material so that a stable colloidal dispersion can be obtained. The solvent must have sufficient volatility so that it can easily be removed when the spray impinges on the heated substrate. Organic solvents such as ethanol, acetone, propanol, toluene are most commonly used. In general, a dispersant, a binder and/or a plasticizer are introduced into the solvent as additives. The dispersant aids in stabilizing the colloidal suspension; the binder adds some strength to a green film initially formed on deposition on to the substrate; and the plasticizer imparts some plasticity to the film. Such practices are known in conventional colloidal processing techniques.

Normally the substrate is heated in the range from about room temperature to about 400° C., but in any case, the substrate is held at a temperature lower than the temperature at which the particles chemically decompose into simpler converted products, such as those which may occur in a spray pyrolysis process. Furthermore, if an organic carrier medium is used, the temperature must be below that which would destroy the organic by breaking bonds, or by chemical reactions with the atmospheric elements to which the organic is exposed. Therefore, the organic liquids useful a carrier media normally have a boiling point below about 400° C. at standard temperature and pressure (STP).

Although the substrate is heated, the dispersing of the particles, such as by spraying or aerosol-assisted deposition, is usually conducted under ordinary conditions of temperature and pressure, such as 25° C. and 1 atmosphere pressure (RTP).

Most powders of any material that have small enough particle size can be suspended in an appropriate solvent as a colloidal solution or suspension is to obtain a powder form of the material to be coated (element or compound) and an average particle size of such material that is sufficiently small enough. Usually fine particles of the material to be coated are less than 10 microns, but in some instances they must be less than 1 micron and even less than 0.5 micron. Although any concentration of particles can be suspended in the carrier medium (i.e., solvent), usually the concentration is in the range from about 0.1 to 10 weight percent, of particles in the solvent.

The materials that can be considered for coating using the subject invention include any pure or mixed metals or compounds, particularly ceramic precursor materials, as for example, all metals, metal oxides, carbides, nitrides, suicides, and the like. Preferred compounds include the elements Y, Zr, elements 57-71, Al, Ce, Pr, Nd, Pm, Sm, Eu, Gd, Th, Dy, Ho, Er, Tm, Yb, Lu, Sc, Ti, V, Cr, Mn, Fe, Co, Ni, Cu, Zn, Bi, Th, Pb, O, C, N, and Si. Although single phase materials can be coated onto the substrate, composite or multilayer coatings are also obtainable.

Multilayer coatings can be created using sequential processing of different colloidal solutions, each containing one or compositions desired in the final coating. The solutions can be delivered to a single nebulizer via different liquid pumps or through different nebulizers. The compositions of the multilayers can be graded in a continuous or discontinuous manner. A coating of continuously graded or discontinuously graded (including stepped) composites can be processed by codepositing different solutions onto a substrate. For example, a coating with a graded composition structure can be processed by simultaneously processing different solutions and controlling the pumping speed of the different solutions through the same or different nebulizers, as illustrated in an example provided below.

After the particles have been dispersed upon the substrate, the resulting green film is sintered at times and temperatures sufficient to produce a final coating having desired properties. Generally, dense coatings require higher sintering temperatures, with fully dense coatings require higher sintering temperatures, with fully dense coatings requiring the highest. If a porous coating is desired, the sintering temperature must be kept sufficiently low to avoid total densification due to particle growth.

A desirable feature of the invention is that the sintered coating can be relatively thick and yet crack free. The coatings also have excellent adhesion to the substrate. Although the thickness of the coating can be varied in the range of less than 1 micron to several hundred microns by controlling the deposition time, the thickness is usually up to about 250 microns, and preferably about 1 to 10 microns; however, thickness of the coating greater than 10 microns can be conveniently produced by controlled dispersion of the colloidal solution and a single sintering step.

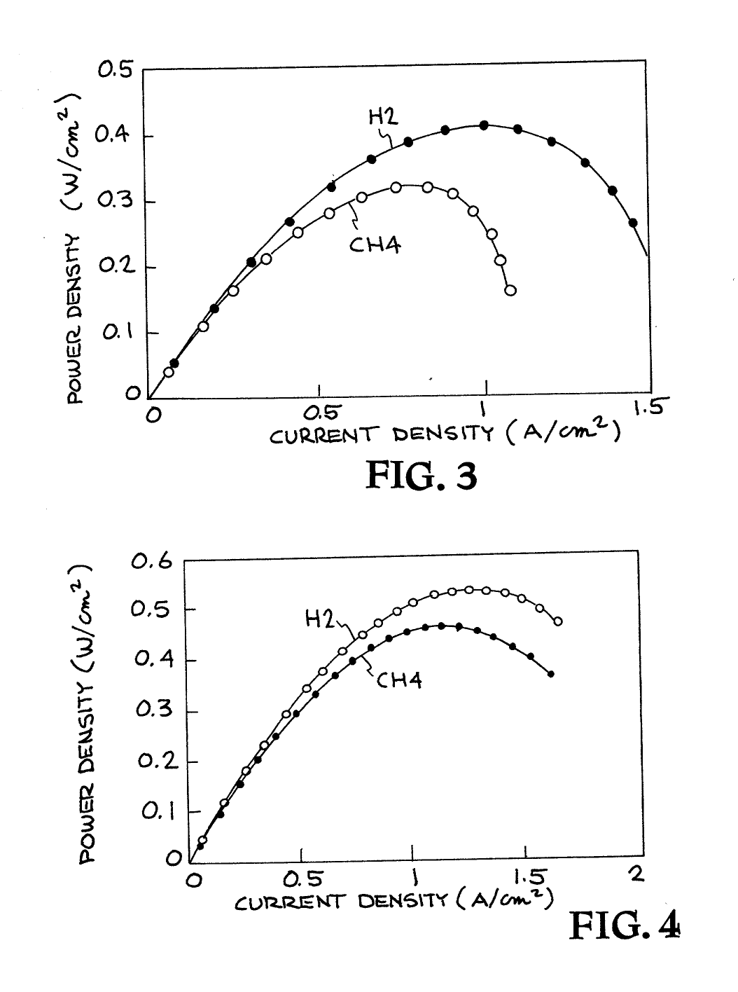

FIG. 2 shows the current-voltage characteristics of fuel cells made in accordance with the invention and operating at a temperature of 550° C. FIG. 3 shows the corresponding power density plots of these fuel cells at 550° C., while FIG. 4 shows power density plots of these fuel cells at 600° C. As shown, in FIG. 3, the peak power for the hydrogen fuel cell is 400 mW/cm². For comparison, it has been reported that a peak power density of 120 mW/cm² at 650° C. (hydrogen fuel) using doped-ceria electrolyte but using NiO/doped-zirconia cermet as the anode. The performance of that fuel cell decreased down to 40 mW/cm² at 550° C., one tenth of the power of the fuel cell made in accordance with this invention. It has also been reported that a peak power density of 100 mW/cm² has been obtained at 550° C. using methane as the fuel. However, this measurement was done using a favorable condition, i.e. asymmetric electrode configuration testing, which has been shown to artificially enhance the actual cell performance. Even so, that enhanced value is still on third of that of the present invention as shown in FIG. 3. In the cell of this invention, when tested at 600° C., as shown in FIG. 4, the power density in H₂ fuel is 530 mW/cm² for hydrogen fuel and 450 mW/cm² for methane.

It has thus been shown that the present invention provides ceria-based solid oxide fuel cells that produce high-performance at intermediate temperatures (400-700° C.). The ceria-based cells may be used with fuels including hydrogen and methane, as well as other hydrocarbons including methane, propane and butane, for example. The low operating temperatures of the cells enable direct use of methane without pre-reforming and without risk of carbon deposition. The fuel cell of this invention has a power output at 500° C. which is 10 times that of currently known fuel cells operating at that temperature. Due to the direct use of methane, such significantly simplifies the fuel cell system, reduces system cost by about 30%, and increases thermodynamic efficiency.

While a particular embodiment of the invention has been illustrated and described, along with a listing of potential fuels therefor and particular parameters, to exemplify and teach the principles of the invention, such are not intended to be limiting. Modifications and changes may become apparent to those skilled in the art, and it is intended that the invention be limited only by the scope of the appended claims.

The Invention Claimed is

1. In a solid oxide fuel cell operating at a temperature in the range of 400-700° C., the improvement comprising;
an anode including doped-ceria,
an electrolyte including doped-ceria, and a cathode including cobalt iron based materials.

2. The improvement of claim 1, wherein said anode is composed of NiO/doped-ceria.

3. The improvement of claim 1, wherein said doped-ceria includes doping elements selected from the group consisting of samarium oxide, gadolinium oxide, yttria oxide, and lanthanide oxide.

4. The improvement of claim 1, wherein said fuel cell includes a pore former to create pores therein.

5. The improvement of claim 4, wherein said pore formed is selected from the group consisting of starch and carbon.

6. The improvement of claim 1, wherein said electrolyte comprises material selected from the group consisting of doped-ceria, doped-zirconia with a thin layer of doped-ceria, and doped-ceria/doped-zirconia.

7. The improvement of claim 1, wherein said electrode is selected from the group consisting of (La, Sr)(Co Fe)O₃, and (La,Ca)(Co, Fe, Mn)O₃.

8. The improvement of claim 1, wherein said doped-ceria in said electrolyte comprises colloidal spray deposited doped-ceria, or aerosol spray casting.

9. The improvement of claim 1, wherein said cobalt iron based material is deposited by colloidal spray deposition or aerosol spray casting.

10. In a method for fabricating ceria-based solid oxide fuel cells, the improvement including forming the ceria-based material by colloidal spray deposition.

11. The improvement of claim 1, additionally including forming an electrode of the fuel cells from a cobalt, iron, manganese based material by colloidal spray deposition.

12. A ceria-based solid oxide fuel cell including:
an anode containing doped-ceria,
an electrolyte containing doped-ceria,
an electrode containing cobalt iron based materials, and
a fuel selected from the group consisting of hydrogen, methane, methanol, propane, butane and other hydrocarbons

13. The fuel cell of claim 12, operating in a temperature range of 400-700° C.

14. The fuel cell of claim 12, wherein said fuel is composed of hydrogen or methane, and wherein the operating temperature is about 550° C.

15. The fuel cell of claim 12, wherein said fuel is hydrogen, and wherein a power output of up to 400 mW/cm is produced at an operating temperature of 550° C.

16. The fuel cell of claim 12, wherein said fuel is methane, and wherein a power output of 320 mW/cm is produced at an operating temperature of 550° C.

17. The fuel cell of claim 12, wherein said anode comprises NiO/doped-ceria.

18. The fuel cell of claim 17, wherein said electrolyte additionally includes doped-zirconia.

19. The fuel cell of claim 18, wherein said electrode comprises (La, Sr)(Co, Fe, Mn) O₃.

20. The fuel cell of claim 19, wherein said doped-ceria is doped with samarium oxide, yttria oxide, lanthamide oxide, or gadolinium oxide.
